(19) United States
(12) Patent Application Publication
(10) Pub. No.: US 2026/0367991 A1
(43) Pub. Date: Nov. 19, 2026

(54) CONTROL APPARATUS, RESOURCE ALLOCATION METHOD AND COMMUNICATION SYSTEM

(71) Applicant: NTT, Inc., Tokyo (JP)

(72) Inventors: Sei KOU, Musahino-shi (JP); Tomoya HATANO, Musahino-shi (JP); Tatsuya SHIMADA, Musahino-shi (JP); Hiroshi O, Musahino-shi (JP)

(73) Assignee: NTT, Inc., Tokyo (JP)

(21) Appl. No.: 19/143,753

(22) PCT Filed: Jan. 19, 2023
(86) PCT No.: PCT/JP2023/001482

§ 371 Date: Jun. 26, 2025

(51) Int. Cl. G06F 9/50

(52) U.S. Cl. CPC G06F 9/5077

(57) ABSTRACT

A control device including: an analysis unit configured to analyze a use situation in each time zone of each of a plurality of applications for processing data transmitted from one or more devices having a communication function on the basis of a monitoring result of a use situation of each of the plurality of applications transmitted from a physical server provided on an edge cloud or a cloud that processes data transmitted from the one or more devices; a resource determination unit configured to determine a resource necessary for each time zone for each application on the basis of a combination of a request processing time of each application and a use situation in each time zone; and a resource control unit configured to control an increase or a decrease in resources allocated to each of the plurality of applications on the basis of a determined resource necessary for each time zone.

### TECHNICAL FIELD

The present invention relates to a control device, a resource allocation method, and a communication system.

### BACKGROUND ART

In order to achieve economization, integrated control, and the like of the Internet of Thing (IoT), a mechanism for transferring a control function of the IoT to an edge cloud or the like is used. An application operating on a physical server located in an edge cloud or a cloud processes data (e.g., a sensor result, an image, or the like) transmitted from an IoT terminal and transmits a processing result as a control signal to the IoT terminal, thereby implementing IoT control. The application operating on a physical server is, for example, software operating on a virtual machine or a container implemented by a virtualization technology in the physical server.

Depending on the IoT service to be provided, it is necessary to suppress the processing time of the application within a certain time in order to ensure the IoT terminal control within a predetermined time. In such a case, certain resources (e.g., a processor such as a central processing unit (CPU) or a graphics processing unit (GPU), and a memory) are allocated to the application. Conventionally, a resource pre-allocation method is generally used as a method for allocating the resources (e.g., refer to Patent Literature 1). As the resource pre-allocation method, assuming the maximum amount of data to be processed simultaneously, a maximum number of IoT terminals to be controlled, or the like, resources that can withstand the maximum load are calculated, and resources based on a calculation result are allocated to the application.

### Citation List

### Patent Literature

Patent Literature 1: JP 2007-148469 A

### SUMMARY OF INVENTION

### Technical Problem

As described above, since resources that can withstand the maximum load are allocated, the utilization efficiency of the resources is poor in a case where the amount of data to be processed, the number of IoT terminals to be controlled, or the like is small. On the other hand, in a case where the amount of data to be processed, the number of IoT terminals to be controlled, or the like exceeds the allocated resources, it is conceivable that there arises an event in which processing cannot be performed in time and the processing time becomes long, which affects the IoT control. As described above, there conventionally is a problem that resource allocation cannot be efficiently performed in the IoT control.

In view of the above circumstances, an object of the present invention is to provide a technique capable of efficiently performing resource allocation in IoT control.

### Solution to Problem

An aspect of the present invention is a control device including: an analysis unit configured to analyze a use situation in each time zone of each of a plurality of applications for processing data transmitted from one or more devices having a communication function on the basis of a monitoring result of a use situation of each of the plurality of applications transmitted from a physical server provided on an edge cloud or a cloud that processes data transmitted from the one or more devices; a resource determination unit configured to determine a resource necessary for each time zone for each application on the basis of a combination of a request processing time of each application and a use situation in each time zone; and a resource control unit configured to control an increase or a decrease in resources allocated to each of the plurality of applications on the basis of a determined resource necessary for each time zone.

An aspect of the present invention is a resource allocation method including: analyzing a use situation in each time zone of each of a plurality of applications for processing data transmitted from one or more devices having a communication function on the basis of a monitoring result of a use situation of each of the plurality of applications transmitted from a physical server provided on an edge cloud or a cloud that processes data transmitted from the one or more devices; determining a resource necessary for each time zone for each application on the basis of a combination of a request processing time for each application and a use situation in each time zone; and controlling an increase or a decrease in resources allocated to each of a plurality of applications on the basis of a determined resource necessary for each time zone.

An aspect of the present invention is a communication system including: a physical server provided on an edge cloud or a cloud that processes data transmitted from one or more devices having a communication function; and a control device that controls the physical server, wherein the physical server includes: a use situation monitoring unit configured to monitor a use situation of each of a plurality of applications that process the data transmitted from the one or more devices; and a communication unit configured to transmit a monitoring result of a use situation of each of the plurality of applications to the control device and receive information on a resource to be allocated to each of the plurality of applications from the control device, and the control device includes: an analysis unit configured to analyze a use situation of each of the plurality of applications in each time zone on the basis of the monitoring result transmitted from the physical server; a resource determination unit configured to determine a resource necessary for each time zone for each application on the basis of a combination of a request processing time for each application and a use situation in each time zone; and a resource control unit configured to control an increase or a decrease in resources allocated to each of the plurality of applications on the basis of a determined resource necessary for each time zone.

### Advantageous Effects of Invention

According to the present invention, resource allocation can be efficiently performed in IoT control.

### BRIEF DESCRIPTION OF DRAWINGS

FIG. 1 A diagram illustrating a configuration example of a communication system according to a first embodiment.

FIG. 2 A diagram illustrating a configuration example of a control device according to the first embodiment.

FIG. 3 A diagram illustrating a configuration example of an application use situation database according to the first embodiment.

FIG. 4 A diagram illustrating another example of an application use situation database according to the first embodiment.

FIG. 5 A diagram illustrating a configuration example of a resource allocation database according to the first embodiment.

FIG. 6 A diagram illustrating a configuration example of an application processing time request database according to the first embodiment.

FIG. 7 A diagram illustrating a configuration example of an application allocation result database according to the first embodiment.

FIG. 8 A sequence diagram illustrating a flow of processing performed by the communication system according to the first embodiment.

FIG. 9 A diagram illustrating a configuration example of a control device according to a second embodiment.

FIG. 10 A flowchart illustrating a flow of processing of the control device according to the second embodiment.

### DESCRIPTION OF EMBODIMENTS

Hereinafter, an embodiment of the present invention will be described with reference to the drawings.

### First Embodiment

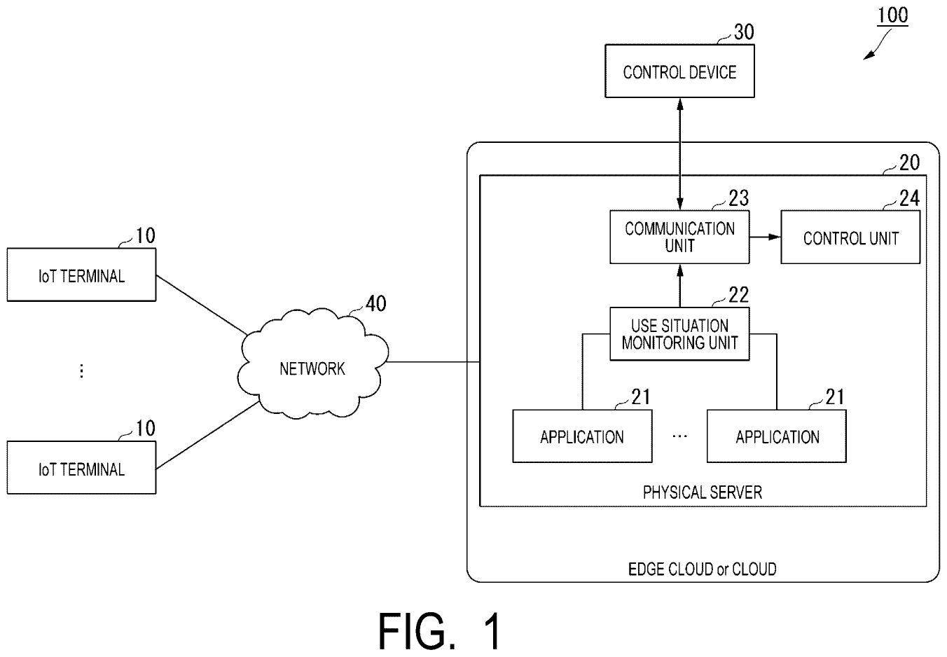

FIG. 1 is a diagram illustrating a configuration example of a communication system 100 according to a first embodiment. The communication system 100 includes one or more IoT terminals 10, one or more physical servers 20, and a control device 30. The number of IoT terminals 10 and the number of physical servers 20 are not particularly limited. The one or more IoT terminals 10 and the one or more physical servers 20 are connected by a network 40. The network 40 is, for example, the Internet.

An IoT terminal 10 is a device that has a unique Internet protocol (IP) address, has a communication function, and can be connected to the Internet. For example, the IoT terminal 10 is a sensor, a camera, or the like, and periodically collects data. In a case where the IoT terminal 10 is a sensor, the sensor periodically collects measurement results. In a case where the IoT terminal 10 is a camera, the camera periodically collects images. The IoT terminal 10 transmits the collected data to the physical server 20 at a predetermined timing. The predetermined timing may be, for example, a timing set in advance, a timing at which data is collected, or a timing requested from the physical server 20.

The physical server 20 processes the data transmitted from the IoT terminal 10 and transmits a control signal including a processing result to the IoT terminal 10. The physical server 20 is a computer on an edge cloud or a cloud. The physical server 20 includes a plurality of applications 21 for processing data transmitted from the IoT terminal 10. An application 21 is, for example, software that operates on a virtual machine or a container implemented by a virtualization technology in the physical server 20.

The physical server 20 dynamically allocates a resource to each application 21 under the control of the control device 30. The resource allocated to each application 21 is, for example, a processor such as a CPU or a GPU, a memory, or a field programmable gate array (FPGA). Note that, in the application 21 at the time of initial startup, the physical server 20 may allocate a resource that can withstand an assumed maximum load as in the related art. In addition, the physical server 20 includes a use situation monitoring unit 22, a communication unit 23, and a control unit 24.

The use situation monitoring unit 22 monitors the use situation of the application 21 (which will be hereinafter referred to as a “target application”) as a resource allocation target. For example, the use situation monitoring unit 22 monitors the amount of traffic flowing to the target application, the number of IoT terminals 10 communicating with the target application, or the like as the use situation of the target application. An IoT terminal 10 communicating with the target application may be specified on the basis of the address information stored in a portion such as the IP of a communication packet. The target application is an application used in the IoT terminal 10. Note that the use situation monitoring unit 22 may simultaneously monitor the use situations of a plurality of applications 21. The use situation monitoring unit 22 transmits a monitoring result of the hourly (time information) use situation (the traffic amount, the number of IoT terminals 10, or the like) to the control device 30 via the communication unit 23.

Note that it is sometimes not efficient to frequently (e.g., in a short period of time) transmit the monitoring result to the control device 30 to change the resource allocation state of the target application. Therefore, the use situation monitoring unit 22 may monitor the use situation of the target application at a certain timing in each time zone. For example, in a case where the time zone is 1 hour, the use situation monitoring unit 22 monitors the use situation of the target application once at a certain timing every 1 hour (e.g., every 1 hour such as 10:00 to 11:00).

Note that the monitoring timing of the use situation of the target application by the use situation monitoring unit 22 is not limited to the timing described above, and may be plural times in each time zone. For example, in a case where the use situation of the target application is set to be monitored once every 1 second, the use situation monitoring unit 22 monitors the use situation of the target application every 1 second. In this case, the use situation monitoring unit 22 may transmit the monitoring result to the control device 30 every time the monitoring result is acquired, or may collectively transmit monitoring results in a certain period to the control device 30.

Then, the use situation monitoring unit 22 transmits the acquired monitoring result to the control device 30. As a result, one monitoring result is transmitted to the control device 30 every 1 hour, so that the change timing of the resource allocation state of the target application can be suppressed.

The communication unit 23 communicates with the control device 30. The communication unit 23 transmits the monitoring result outputted from the use situation monitoring unit 22 to the control device 30. The communication unit 23 receives control information transmitted from the control device 30. The control information transmitted from the control device 30 includes, for example, information regarding resource allocation for each application 21. For example, the control information includes information indicating how much and which resources are to be allocated to which application.

The control unit 24 dynamically changes a resource to be allocated to the target application according to the control information transmitted from the control device 30.

The control device 30 allocates a resource to the target application in the physical server 20 on the basis of the monitoring result transmitted from the physical server 20.

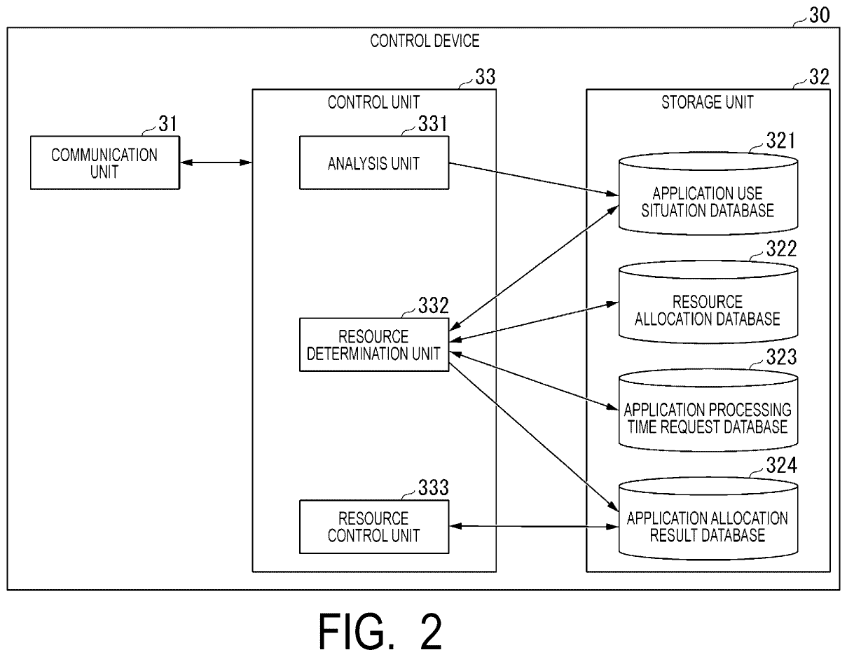

FIG. 2 is a diagram illustrating a configuration example of the control device 30 according to the first embodiment. The control device 30 includes a communication unit 31, a storage unit 32, and a control unit 33.

The communication unit 31 communicates with the physical server 20. The communication unit 31 receives the monitoring result transmitted from the physical server 20. The communication unit 31 transmits control information including the allocation result to the physical server 20.

The storage unit 32 stores an application use situation database 321, a resource allocation database 322, an application processing time request database 323, and an application allocation result database 324. The storage unit 32 includes a storage device such as a magnetic storage device or a semiconductor storage device. The application use situation database 321 is a database in which information regarding the use situation of the application 21 is registered. For example, information such as the traffic amount or the number of IoT terminals is registered in the application use situation database 321 in association with each time zone. The application use situation database 321 is provided for each application 21.

The resource allocation database 322 is a database in which information regarding a resource to be allocated to the target application is registered. For example, information on a necessary resource allocation amount is registered in the resource allocation database 322 for each combination of the request processing time and the traffic amount or the number of IoT terminals. As the request processing time in the resource allocation database 322, a processing time in a range that can be requested by the target application is registered. The resource allocation database 322 is provided for each application 21.

The application processing time request database 323 is a database in which information regarding a request processing time requested by each application 21 is registered. Information on the request processing time of each application 21 registered in the application processing time request database 323 is registered in advance according to a request from the application 21 or a request from the user. Therefore, the information on the request processing time of each application 21 registered in the application processing time request database 323 may be corrected as necessary.

The application allocation result database 324 is a database in which information regarding a resource to be allocated to each application 21 is registered. For example, information on necessary resources is registered in the application allocation result database 324 for each time zone. The application allocation result database 324 is provided for each application 21.

The control unit 33 controls the entire control device 30. The control unit 33 includes a processor such as a CPU and a memory. The control unit 33 implements the functions of an analysis unit 331, a resource determination unit 332, and a resource control unit 333 by executing a program.

Some or all of the analysis unit 331, the resource determination unit 332, and the resource control unit 333 may be implemented by hardware (including a circuitry) such as an application specific integrated circuit (ASIC), a programmable logic device (PLD), or a field programmable gate array (FPGA) or by cooperation of software and hardware. The program may be recorded in a computer-readable recording medium. The computer-readable recording medium is, for example, a non-transitory storage medium including a portable medium such as a flexible disk, a magneto-optical disk, a read only memory (ROM), or a compact disc-ROM (CD-ROM), and a storage device such as a hard disk built in a computer system. The program may be transmitted via an electrical communication line.

Some of the functions of the analysis unit 331, the resource determination unit 332, and the resource control unit 333 are not necessarily installed in the control device 30 in advance, and may be implemented by installing an additional application program in the control device 30.

The analysis unit 331 analyzes the use situation of the target application in each time zone by using the monitoring result transmitted from the physical server 20. The analysis unit 331 newly writes or overwrites and registers the analysis result in the application use situation database 321 in real time. Note that, when registering the analysis result in the application use situation database 321, the analysis unit 331 may register the analysis result so as to leave analysis results of the past several times. As a result, it is possible to grasp the transition of the resource use situation of the target application.

The resource determination unit 332 determines a resource to be allocated to the target application for each time zone on the basis of each database stored in the storage unit 32. The resource determination unit 332 registers information on a resource to be allocated to the target application determined for each time zone in the application allocation result database 324.

The resource control unit 333 refers to the application allocation result database 324 and acquires information on a resource necessary for each time zone for each target application. The resource control unit 333 controls an increase or a decrease in resources to be allocated to each target application in a state where the target application is activated, on the basis of the acquired information on a resource necessary for each time zone for each target application. The dynamic increase/decrease control of resources is implemented using an existing technique such as hot plug.

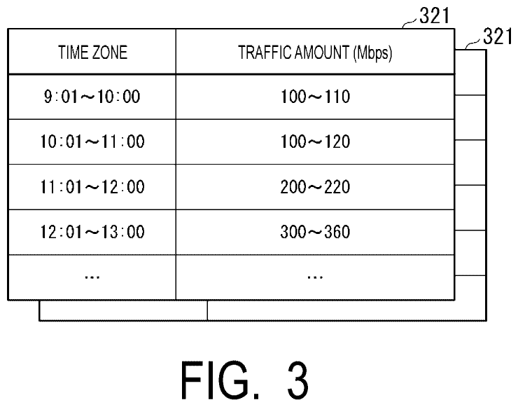

FIG. 3 is a diagram illustrating a configuration example of the application use situation database 321 according to the first embodiment. The application use situation database 321 illustrated in FIG. 3 includes a plurality of records in which values of a time zone and a traffic amount are associated with each other. The time zone represents a time zone in which the monitoring result is obtained in the physical server 20. The traffic amount represents a value of the traffic amount included in the monitoring result. That is, the traffic amount registered in the application use situation database 321 represents the traffic amount processed by the target application measured by the physical server 20 in the associated time zone.

Note that, although FIG. 3 illustrates a configuration in which information on one traffic amount is registered in association with each time zone, information on a plurality of traffic amounts may be registered in association with each time zone. The information on the plurality of traffic amounts includes, for example, information on traffic amounts (e.g., a traffic amount observed in a time zone of 9:01 to 10:00 on a certain day, a traffic amount observed in a time zone of 9:01 to 10:00 on another day, and the like) in the same time zone on different dates.

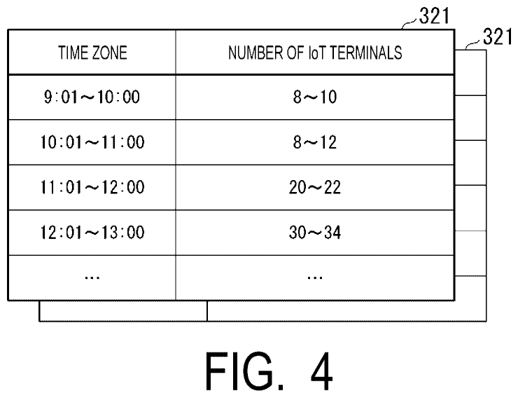

FIG. 4 is a diagram illustrating another example of the application use situation database 321 according to the first embodiment. The application use situation database 321 illustrated in FIG. 4 includes a plurality of records in which values of a time zone and the number of IoT terminals are associated with each other. The time zone represents a time zone in which the monitoring result is obtained in the physical server 20. The number of IoT terminals represents a value of the number of IoT terminals 10 included in the monitoring result. That is, the number of IoT terminals registered in the application use situation database 321 represents the number of IoT terminals 10 controlled by the target application measured by the physical server 20 in the associated time zone.

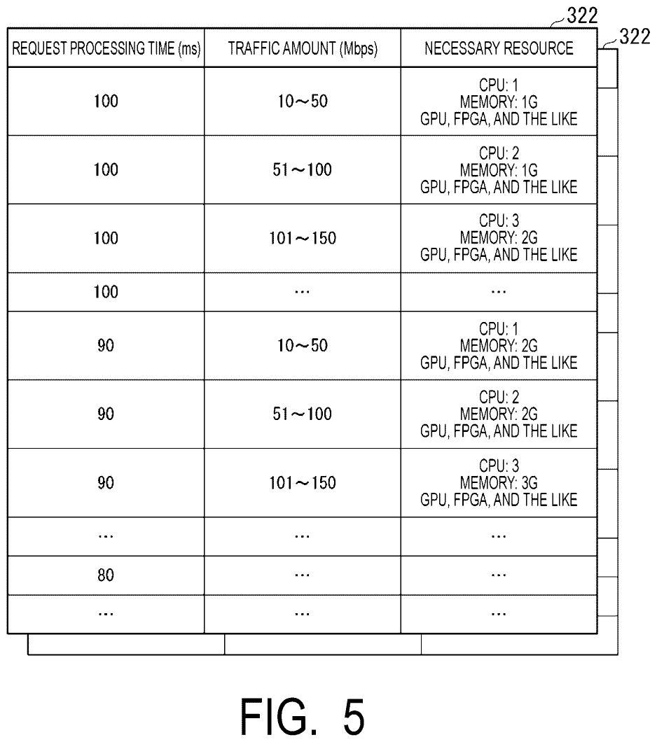

FIG. 5 is a diagram illustrating a configuration example of the resource allocation database 322 according to the first embodiment. The resource allocation database 322 includes a plurality of records in which values of a request processing time, a traffic amount, and a necessary resource are associated with each other. The request processing time represents a processing time requested by the target application. Note that, as the request processing time in the resource allocation database 322, a processing time in a range that can be requested by the target application is registered. The traffic amount represents a traffic amount of the target application. Note that, as the traffic amount in the resource allocation database 322, a traffic amount in a range that can be assumed by the target application is registered. The necessary resource represents a resource required for processing under a condition of a combination of a request processing time and a traffic amount.

FIG. 5 shows that one CPU, a memory of 1 G, a CPU, an FPGA, AND the like are required in a case where the request processing time is “100 ms” and the traffic amount is “10 to 50 Mbps”. Note that, although FIG. 5 illustrates an example in which information on resources required for the processing under the condition of the combination of the request processing time and the traffic amount is registered, information on the number of IoT terminals 10 instead of the traffic amount may be registered in the resource allocation database 322.

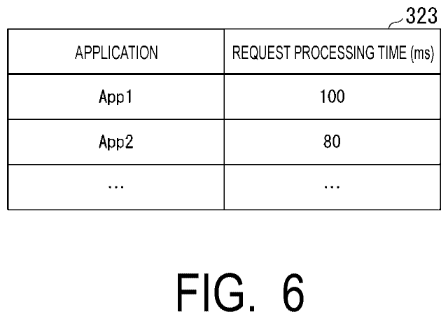

FIG. 6 is a diagram illustrating a configuration example of the application processing time request database 323 according to the first embodiment. The application processing time request database 323 includes a plurality of records in which values of an application and a request processing time are associated with each other. The application represents an application 21 implemented in the physical server 20. The request processing time represents a processing time requested by the target application 21. The request processing time in the application processing time request database 323 is set according to a request from the application 21 or a request from the user.

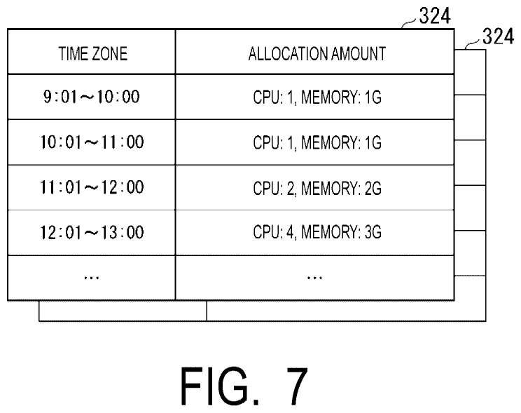

FIG. 7 is a diagram illustrating a configuration example of the application allocation result database 324 according to the first embodiment. The application allocation result database 324 includes a plurality of records in which values of a time zone and an allocation amount are associated with each other. The time zone in the application allocation result database 324 represents a time zone in which the resource allocation control of the target application is performed. The allocation amount represents a resource to be allocated to the target application in the associated time zone. FIG. 7 shows that “one CPU and a memory of 1 G” are allocated as resources to a certain target application in the time zone of “9:01 to 10:00”.

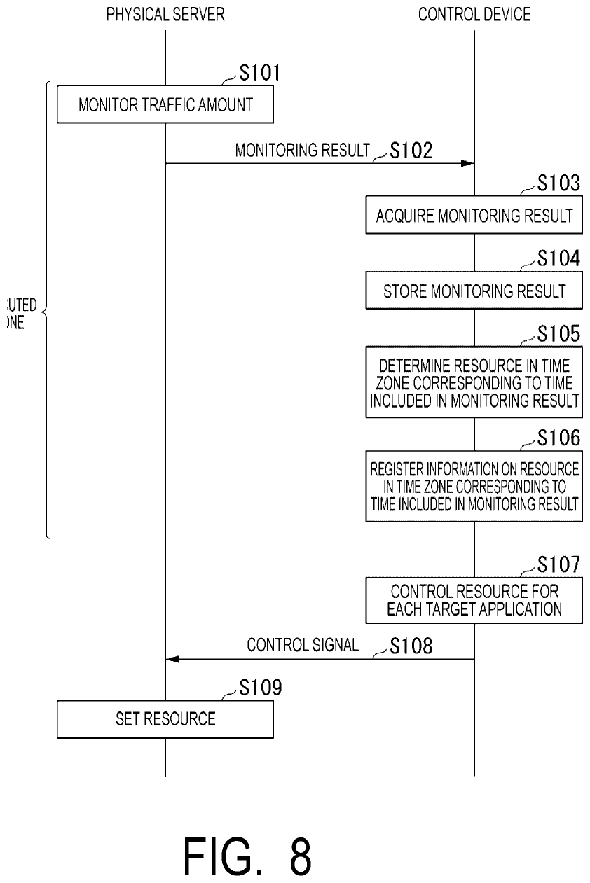

FIG. 8 is a sequence diagram illustrating a flow of processing performed by the communication system 100 according to the first embodiment. In FIG. 8, a case where the traffic amount of the target application is monitored will be described as an example.

The use situation monitoring unit 22 of the physical server 20 monitors the amount of traffic flowing to the target application (step S101). The use situation monitoring unit 22 transmits the monitoring result including monitored results (e.g., an identifier, a traffic amount) together with monitored time information to the control device 30 in real time via the communication unit 23 (step S102). For example, the use situation monitoring unit 22 transmits the monitoring result including the identifier (e.g., App 1) of the target application, the time information (e.g., 20XX/MM/DD 09:30:00), and the traffic amount (e.g., 105 Mbps) to the control device 30 in real time via the communication unit 23.

The communication unit 31 of the control device 30 receives the monitoring result transmitted from the physical server 20. The analysis unit 331 acquires the monitoring result received by the communication unit 31 (step S103). The analysis unit 331 analyzes the acquired monitoring result. As a result, the analysis unit 331 acquires the identifier of the target application, the time information, and the traffic amount information included in the monitoring result. The analysis unit 331 stores the acquired information in the application use situation database 321 (step S104).

Specifically, the analysis unit 331 reads the application use situation database 321 corresponding to the identifier (e.g., App1) of the target application from the application use situation database 321 stored in the storage unit 32. The analysis unit 331 acquires a record in a time zone specified by the acquired time information (e.g., 20XX/MM/DD 09:30:00) from the item of the time zone in the read application use situation database 321. As a result, the analysis unit 331 acquires a record of the time zone “9:01 to 10:00”. Then, the analysis unit 331 registers the information on the acquired traffic amount (e.g., 105 Mbps) in the item of the traffic amount of the acquired record.

On the basis of each database stored in the storage unit 32, the resource determination unit 332 determines a resource in a time zone corresponding to the time included in the monitoring result for each target application (step S105). Specifically, the resource determination unit 332 first refers to the application processing time request database 323 and acquires information on a request processing time for each target application. Next, the resource determination unit 332 refers to the application use situation database 321 and acquires information on a time zone corresponding to the time included in the monitoring result and the traffic amount in the time zone for each target application. Furthermore, the resource determination unit 332 refers to the resource allocation database 322 and acquires information on a necessary resource corresponding to a combination of the acquired request processing time and the traffic amount in the time zone for each target application. Then, the resource determination unit 332 registers the acquired information on a necessary resource for each target application in the application allocation result database 324 in association with the time zone corresponding to the time included in the monitoring result (step S106).

The processing from step S101 to step S106 is executed in each time zone. As a result, information on the traffic amount in each time zone is registered in the application use situation database 321 as illustrated in FIG. 3, and information on the allocation amount in each time zone is registered in the application allocation result database 324 as illustrated in FIG. 7.

The resource control unit 333 controls a resource for each target application on the basis of the application allocation result database 324 (step S107). Specifically, the resource control unit 333 refers to the application allocation result database 324, grasps a resource necessary in each time zone, and generates a control signal including information on an allocation amount for each target application in order to increase or decrease resources in a state of being activated with respect to the target application. For example, when grasping that “one CPU and a memory of 1 G” are necessary as resources of a certain target application in “9:01 to 10:00”, the resource control unit 333 generates a control signal including an identifier of the certain target application and information (“one CPU and a memory of 1 G”) on an allocation amount of the certain target application. The resource control unit 333 transmits the generated control signal to the physical server 20 via the communication unit 31 (step S108). Note that the control device 30 allocates a resource with reference to the application allocation result database 324 in each time zone.

The communication unit 23 of the physical server 20 receives the control signal transmitted from the control device 30. The control unit 24 sets a resource of the target application on the basis of the received control signal (step S109). In this manner, it is possible to allocate a resource suitable for each time zone. As a result, the resource utilization efficiency can be improved.

According to the communication system 100 configured as described above, the physical server 20 includes the use situation monitoring unit 22 that monitors the use situation of each of the plurality of applications 21, and the communication unit 23 that transmits the monitoring result of the use situation of each of the plurality of applications 21 to the control device 30 and receives information on a resource allocated to each of the plurality of applications 21 from the control device 30, and the control device 30 includes the analysis unit 331 that analyzes the use situation of each application 21 in each time zone on the basis of the monitoring result transmitted from the physical server 20, the resource determination unit 332 that determines a resource necessary for each time zone for each application 21 on the basis of a combination of the request processing time for each application 21 and the use situation in each time zone, and the resource control unit 333 that controls an increase or a decrease in resources allocated to each of the plurality of applications 21 on the basis of the determined resource necessary for each time zone. As a result, it is possible to dynamically allocate a resource suitable for each time zone. As a result, resource allocation can be efficiently performed in IoT control.

Furthermore, the use situation of each of the plurality of applications 21 is the traffic amount flowing to each of the plurality of applications 21 or the number of IoT terminals 10 communicating with any of the plurality of applications 21, and the resource determination unit 332 determines a resource necessary for each time zone for each application 21 on the basis of a combination of the request processing time for each application and the traffic amount in each time zone or the number of IoT terminals 10. At this time, the resource determination unit 332 refers to the resource allocation database 322 in which information on a necessary resource is associated on the basis of a combination of the request processing time and the traffic amount or the number of IoT terminals 10. As described above, in the resource allocation database 322, information on a necessary resource is associated in advance on the basis of a combination of the request processing time and the traffic amount or the number of IoT terminals 10. The resource determination unit 332 can easily determine information on a resource necessary for each target application by referring to the resource allocation database 322.

### Second Embodiment

In a second embodiment, a configuration corresponding to a case where a use situation of an application rapidly changes will be described. The case where the use situation of the application rapidly changes is, for example, a case where the traffic amount processed by a certain target application increases or decreases by a threshold or more, or a case where the number of IoT terminals controlled by a certain target application increases or decreases by a threshold or more. The processing described in the second embodiment may be executed, for example, after the resource allocation according to the first embodiment is performed, or may be executed after other resource allocation (conventional resource allocation) is performed. In the second embodiment, a system configuration is similar to that of the first embodiment. Hereinafter, differences from the first embodiment will be mainly described.

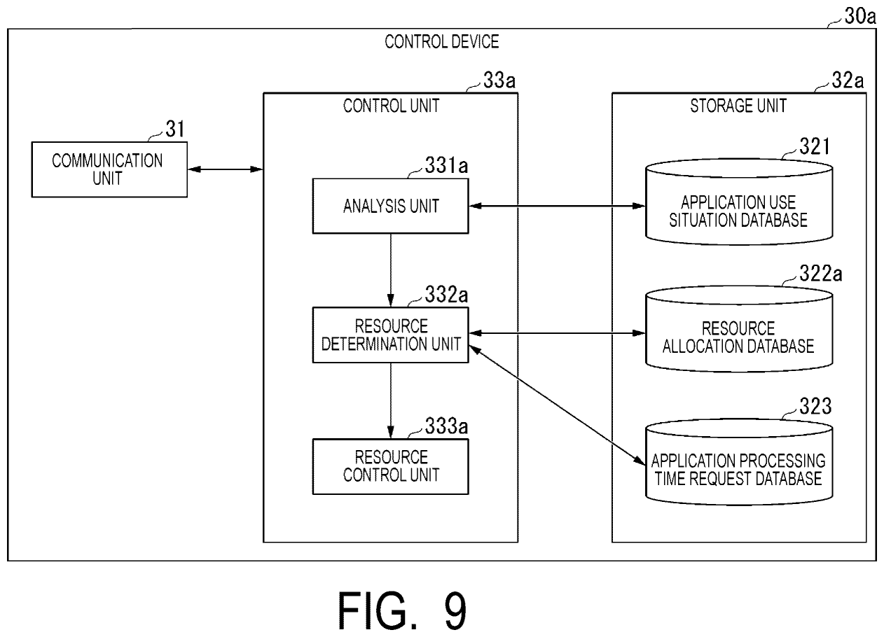

FIG. 9 is a diagram illustrating a configuration example of a control device 30a according to the second embodiment. The control device 30a includes a communication unit 31, a storage unit 32a, and a control unit 33a. The configuration of the control device 30a is different from that of the control device 30 in that the storage unit 32a and the control unit 33a are provided instead of the storage unit 32 and the control unit 33. The other configurations of the control device 30a are similar to those of the control device 30.

The storage unit 32a stores an application use situation database 321, a resource allocation database 322a, and an application processing time request database 323. In the second embodiment, the storage unit 32a may not include the application allocation result database 324. Note that the storage unit 32a may include an application allocation result database 324 in a case where the processing of the second embodiment is performed after the resource allocation according to the first embodiment is performed. In the second embodiment, since it is assumed that the use situation of the resource rapidly changes, it is also assumed that the allocation amount registered in the application allocation result database 324 cannot cope with the change. Therefore, in the second embodiment, the information registered in the application allocation result database 324 is not used. Therefore, the storage unit 32a may not include the application allocation result database 324.

The resource allocation database 322a according to the second embodiment is basically similar to the resource allocation database 322 according to the first embodiment. However, although information on the traffic amount in a range that can be assumed for the target application is registered in the resource allocation database 322 in the first embodiment, the traffic amount may be larger than the traffic amount in a range that can be assumed for the target application depending on the situation in the second embodiment. Therefore, information on a resource necessary when the traffic amount (or the number of IoT terminals 10) is larger than the assumed maximum load is registered in the resource allocation database 322a in the second embodiment.

The control unit 33a controls the entire control device 30a. The control unit 33a includes a processor such as a CPU and a memory. The control unit 33a implements the functions of an analysis unit 331a, a resource determination unit 332a, and a resource control unit 333a by executing a program.

Some or all of the analysis unit 331a, the resource determination unit 332a, and the resource control unit 333a may be implemented by hardware (including a circuitry) such as an ASIC, a PLD, or an FPGA or by cooperation of software and hardware. The program may be recorded in a computer-readable recording medium. The computer-readable recording medium is, for example, a non-transitory storage medium including a portable medium such as a flexible disk, a magneto-optical disk, a ROM, or a CD-ROM, and a storage device such as a hard disk built in a computer system. The program may be transmitted via an electrical communication line.

Some of the functions of the analysis unit 331a, the resource determination unit 332a, and the resource control unit 333a are not necessarily installed in the control device 30 in advance, and may be implemented by installing an additional application program in the control device 30.

The analysis unit 331a analyzes the use situation of the target application in each time zone by using the monitoring result transmitted from the physical server 20. More specifically, the analysis unit 331a determines whether there is a target application (which will be hereinafter referred to as a “change target application”) whose resource use situation has rapidly changed or not on the basis of the monitoring result transmitted from the physical server 20 and the application use situation database 321. A rapid change in the resource use situation means that, for example, a rapid increase or a rapid decrease occurs in the traffic amount, the number of IoT terminals 10, or the like.

The analysis unit 331a determines that there is a change target application in a case where use situation information (e.g., the traffic amount or the number of IoT terminals 10) included in the acquired monitoring result has changed (e.g., increased or decreased) by a predetermined threshold or more in comparison with the use situation information (e.g., the traffic amount or the number of IoT terminals 10) included in a monitoring result acquired immediately before. On the other hand, the analysis unit 331a determines that there is no change target application in a case where the use situation information included in the acquired monitoring result has not changed (e.g., increased or decreased) by a predetermined threshold or more in comparison with the use situation information included in a monitoring result acquired immediately before.

Here, the monitoring result acquired immediately before is determined on the basis of an interval of acquisition of monitoring results. For example, in a case where the monitoring result is acquired every 1 hour, “20XX/MM/DD 09:01:00 to 20XX/MM/DD 10:00:00” which is a “monitoring result acquired immediately before” a monitoring result acquired in “20XX/MM/DD 10:01:00 to 20XX/MM/DD 11:00:00” is the monitoring result acquired immediately before. That is, the analysis unit 331a compares a monitoring result acquired in “20XX/MM/DD 10:01:00 to 20XX/MM/DD 11:00:00” with a monitoring result acquired in “20XX/MM/DD 09:01:00 to 20XX/MM/DD 10:00:00”. For example, in a case where the monitoring result is acquired once every 1 second, the analysis unit 331a compares a monitoring result acquired at “20XX/MM/DD 09:30:00” with a monitoring result acquired at “20XX/MM/DD 09:29:59”.

The analysis unit 331a performs the above determination processing for each target application, and determines that there is a change target application in a case where there is at least one target application that has changed (e.g., increased or decreased) by a predetermined threshold or more. Note that the analysis unit 331a may determine that there is a change target application in a case where the use situation information (e.g., the traffic amount or the number of IoT terminals 10) included in the acquired monitoring result has changed by a predetermined threshold or more in comparison with the average value of the use situation information (e.g., the traffic amount or the number of IoT terminals 10) included in the latest several monitoring results, and determine that there is no change target application in a case where the use situation information has not changed by a predetermined threshold or more. For example, in a case where a certain time zone is “10:01 to 11:00”, a monitoring result acquired in “9:01 to 10:00” which is a monitoring result acquired immediately before may be used.

When it is determined that there is a change target application, the analysis unit 331a notifies the resource determination unit 332a of information regarding the change target application. For example, the analysis unit 331a notifies the resource determination unit 332a of a flag indicating that the priority is high, an identifier of the change target application, and the use situation of the change target application (e.g., information such as a traffic amount or the number of IoT terminals 10).

In response to the notification from the analysis unit 331a, the resource determination unit 332a determines a resource to be allocated to the change target application included in the notification from the analysis unit 331a. The resource determination unit 332a notifies the resource control unit 333a of information on a resource to be allocated to the change target application obtained as a determination result. As described above, in the second embodiment, the resource determination unit 332a notifies the resource control unit 333a of resource information in the push type.

In response to the notification from the resource determination unit 332a, the resource control unit 333a controls an increase or a decrease in resources to be allocated to the change target application in a state where the change target application is activated, on the basis of the information on necessary resources of the change target application included in the notification.

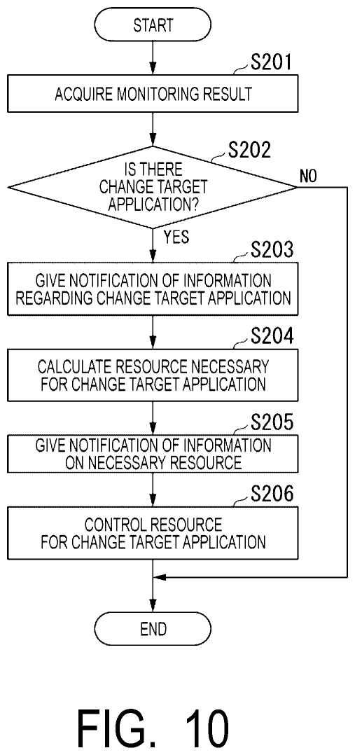

FIG. 10 is a flowchart illustrating a flow of processing of the control device 30a according to the second embodiment. In FIG. 10, a case where the traffic amount of the target application is monitored will be described as an example.

The communication unit 31 of the control device 30a receives the monitoring result transmitted from the physical server 20. Here, it is assumed that the monitoring result includes an identifier (e.g., App1) of the target application, time information (e.g., 20XX/MM/DD 09:30:00), and traffic amount information (e.g., 105 Mbps). The analysis unit 331 a acquires the monitoring result received by the communication unit 31 (step S201). The analysis unit 331a analyzes the acquired monitoring result. As a result, the analysis unit 331a acquires the identifier of the target application, the time information, and the traffic amount information included in the monitoring result.

The analysis unit 331a determines whether there is a change target application or not on the basis of the acquired monitoring result and the application use situation database 321 (step S202). This determination is made for each target application included in the monitoring result. In a case where the monitoring result includes identifiers “App1” and “App2” of target applications, the analysis unit 331a determines whether there is a change target application or not on the basis of the monitoring result of the identifier “App1” of a target application and the application use situation database 321 corresponding to the identifier “App1” of the target application, and determines whether there is a change target application or not on the basis of the monitoring result of the identifier “App2” of a target application and the application use situation database 321 corresponding to the identifier “App2” of the target application.

The analysis unit 331a reads the application use situation database 321 corresponding to the identifier (e.g., App1) of the target application from the application use situation database 321 stored in the storage unit 32a. The analysis unit 331a acquires a record of a time zone (e.g., a previous time zone) before the time zone specified by the acquired time information (e.g., 20XX/MM/DD 09:30:00) from the item of the time zone in the read application use situation database 321. As a result, the analysis unit 331a acquires a record of the time zone “8:01 to 9:00”. Then, the analysis unit 331a compares the traffic amount (the traffic amount included in the monitoring result acquired immediately before) registered in the item of the traffic amount of the acquired record with the traffic amount (e.g., 105 Mbps) included in the monitoring result.

As a result of the comparison, the analysis unit 331a determines that there is a change target application in a case where the traffic amount (e.g., 105 Mbps) included in the monitoring result has changed by a predetermined threshold or more from the traffic amount included in the monitoring result acquired immediately before. On the other hand, the analysis unit 331a determines that there is no change target application in a case where there is no target application whose traffic amount included in the monitoring result has increased or decreased by a predetermined threshold or more from the traffic amount included in the monitoring result acquired immediately before.

If it is determined that there is a change target application (step S202: YES), the analysis unit 331a notifies the resource determination unit 332a of information regarding the change target application (step S203). For example, the analysis unit 331a notifies the resource determination unit 332a of information including a flag (e.g., 1111 means that the resource needs to be changed immediately), an identifier (e.g., App1) of the change target application, and a use situation (e.g., traffic amount=105 Mbps) of the change target application.

In response to the notification from the analysis unit 331a, the resource determination unit 332a determines a resource to be allocated to the change target application included in the notification from the analysis unit 331a (step S204). Specifically, the resource determination unit 332a refers to the application processing time request database 323 stored in the storage unit 32a, and acquires information on the request processing time corresponding to the identifier (e.g., App1) of the change target application. Then, the resource determination unit 332a refers to the resource allocation database 322, and acquires information on a necessary resource corresponding to a combination of the acquired request processing time and the traffic amount of the change target application included in the notification from the analysis unit 331a for each change target application.

The resource determination unit 332a notifies the resource control unit 333a of information on the necessary resource acquired for each change target application (step S205). In response to the notification from the resource determination unit 332a, the resource control unit 333a controls the resource for each change target application (step S206). Specifically, the resource control unit 333a generates a control signal including information on a necessary resource acquired for each change target application included in the notification, in order to increase or decrease resources in a state of being activated for the change target application included in the notification. The resource control unit 333a transmits the generated control signal to the physical server 20 via the communication unit 31. As a result, the resource of the change target application can be quickly changed.

If the analysis unit 331a determines in the process of step S202 that there is no change target application (step S202: NO), the processing in FIG. 10 ends.

According to the communication system 100 in the second embodiment configured as described above, it is possible to obtain effects similar to those of the first embodiment.

Furthermore, in the communication system 100 according to the second embodiment, when a monitoring result is obtained, the control device 30a compares information on the use situation included in the obtained monitoring result with information on a past use situation. Then, in a case where the control device 30a determines, as a result of the comparison, that there is a target application whose use situation has rapidly changed, the control device 30a operates to change the resource to be allocated to the target application whose use situation has rapidly changed. As a result, the resource of the change target application can be changed. Therefore, even in a case where the traffic amount rapidly increases or decreases, it is possible to suppress a processing delay by quickly increasing or decreasing the resources of the change target application.

### Modification of Second Embodiment

Although a configuration in which the analysis unit 331a compares a monitoring result acquired at a certain timing with a monitoring result acquired immediately before is described in the above-described embodiment as the process of determining whether there is a change target application or not, the monitoring result to be compared is not limited to the monitoring result acquired immediately before. For example, the monitoring result to be compared may be a maximum value or an average value of monitoring results in a certain time zone “10:01 to 11:00” acquired so far. A certain time zone acquired so far is the same time zone as the time zone to be compared. That is, the analysis unit 331a may compare a monitoring result acquired in the current time zone “10:01 to 11:00” with the maximum value or the average value of monitoring results in the current time zone “10:01 to 11:00” acquired in the past.

### Modification 1 Common to First Embodiment and Second Embodiment

It is also assumed that the resources of the plurality of applications 21 increase and exceed the resources of the physical server 20. In such a case, the control unit 24 may suppress the resources of the physical server 20 by transferring a part of the processing to another server using an existing migration technology.

### Modification 2 Common to First Embodiment and Second Embodiment

In each of the above-described embodiments, a parameter different from the traffic amount and the number of IoT terminals 10 may be used, or both the traffic amount and the number of IoT terminals 10 may be used as the use situation of the target application.

Although the embodiments of the present invention have been described in detail with reference to the drawings, specific configurations are not limited to the embodiments and include design and the like within the gist of the present invention.

### Industrial Applicability

The present invention can be applied to a resource allocation technique for a physical server that controls an IoT terminal.

### REFERENCE SIGNS LIST

10 IoT terminal
20 Physical server
21 Application
22 Use situation monitoring unit
23 Communication unit
24 Control unit
30, 30a Control device
31 Communication unit
32, 32a Storage unit
33,33a Control unit
321 Application use situation database
322, 322a Resource allocation database
323 Application processing time request database
324 Application allocation result database
331, 331a Analysis unit
332, 332aResource determination unit
333, 333aResource control unit

1. A control device comprising:
an analyzer configured to analyze a use situation in each time zone of each of a plurality of applications for processing data transmitted from one or more devices having a communication function on a basis of a monitoring result of a use situation of each of the plurality of applications transmitted from a physical server provided on an edge cloud or a cloud that processes data transmitted from the one or more devices;
a resource determiner configured to determine a resource necessary for each time zone for each application on a basis of a combination of a request processing time of each application and a use situation in each time zone; and
a resource controller configured to control an increase or a decrease in resources allocated to each of the plurality of applications on a basis of a determined resource necessary for each time zone.

2. The control device according to claim 1,
wherein the use situation is a traffic amount flowing to each of the plurality of applications or a number of the one or more devices communicating with any of the plurality of applications, and
the resource determiner determines a resource necessary for each time zone for each application on a basis of a combination of a request processing time for each application and a traffic amount in each time zone or a number of the one or more devices.

3. The control device according to claim 1, further comprising:
a resource allocation database in which information on a necessary resource is registered for each combination of a request processing time representing a time required for processing requested by an application and a use situation; and
an application processing time request database in which information on the request processing time of each of the plurality of applications is registered,
wherein the resource determiner determines a resource necessary for each time zone for each application by acquiring at least identification information of each application and information on a use situation of each application as a result of analysis by the analyzer, acquiring information on the request processing time of each application with reference to an application processing time request database, and acquiring information on the necessary resource associated with a combination of the acquired request processing time of each application and the use situation of each application with reference to the resource allocation database.

4. The control device according to claim 1,
wherein the analyzer notifies the resource determiner of information regarding an application whose use situation of a resource has rapidly changed in a case where there is an application whose use situation of a resource has rapidly changed on a basis of the monitoring result,
the resource determiner determines a resource to be allocated to the application included in notification from the analyzer in response to the notification from the analyzer, and
the resource controller further controls an increase or a decrease in resources to be allocated to the application whose use situation of a resource has rapidly changed.

5. The control device according to claim 4,
wherein the analyzer compares information on a use situation included in a monitoring result with information on a use situation included in a monitoring result acquired in past, and determines whether there is an application whose use situation of a resource has rapidly changed or not.

6. A resource allocation method comprising:
analyzing a use situation in each time zone of each of a plurality of applications for processing data transmitted from one or more devices having a communication function on a basis of a monitoring result of a use situation of each of the plurality of applications transmitted from a physical server provided on an edge cloud or a cloud that processes data transmitted from the one or more devices;
determining a resource necessary for each time zone for each application on a basis of a combination of a request processing time for each application and a use situation in each time zone; and
controlling an increase or a decrease in resources allocated to each of a plurality of applications on a basis of a determined resource necessary for each time zone.

7. A communication system comprising: a physical server provided on an edge cloud or a cloud that processes data transmitted from one or more devices having a communication function; and a control device that controls the physical server,
wherein the physical server includes:
a use situation monitor configured to monitor a use situation of each of a plurality of applications that process the data transmitted from the one or more devices; and
a communicator configured to transmit a monitoring result of a use situation of each of the plurality of applications to the control device and receive information on a resource to be allocated to each of the plurality of applications from the control device, and
the control device includes:
an analyzer configured to analyze a use situation of each of the plurality of applications in each time zone on a basis of the monitoring result transmitted from the physical server;
a resource determiner configured to determine a resource necessary for each time zone for each application on a basis of a combination of a request processing time for each application and a use situation in each time zone; and
a resource controller configured to control an increase or a decrease in resources allocated to each of the plurality of applications on a basis of a determined resource necessary for each time zone.
